(19) United States
(12) Patent Application Publication
(10) Pub. No.: US 2014/0300444 A1
(43) Pub. Date: Oct. 9, 2014

(54) LAMINATED ELECTRICAL FUSE

(71) Applicants: ALBERT ENRIQUEZ, Lipa (PH); DEMETRIO CRISTE, Lipa (PH); CONRADO DE LEON, Lipa (PH); CRISPIN ZULUETA, Lipa (PH); ROEL RETARDO, Lipa (PH); JOHN SEMANA, Lipa (PH); Gordon Todd Dietsch, Park Ridge, IL (US)

(72) Inventors: ALBERT ENRIQUEZ, Lipa (PH); DEMETRIO CRISTE, Lipa (PH); CONRADO DE LEON, Lipa (PH); CRISPIN ZULUETA, Lipa (PH); ROEL RETARDO, Lipa (PH); JOHN SEMANA, Lipa (PH); Gordon Todd Dietsch, Park Ridge, IL (US)

(73) Assignee: LITTELFUSE, INC., Chicago, IL (US)

(21) Appl. No.: 14/313,082

(22) Filed: Jun. 24, 2014

Related U.S. Application Data
(63) Continuation-in-part of application No. 14/252,846, filed on Apr. 15, 2014.
Application No. 14/252,846 is a continuation-in-part of application No. 13/826,058, filed on Mar. 14, 2013.

(51) Int. Cl. H01H 85/50

(52) U.S. Cl. CPC H01H 85/50
USPC 337/295

(57) ABSTRACT

A compact, high breaking capacity fuse that includes a top insulative layer, at least one intermediate insulative layer, and a bottom insulative layer arranged in a vertically stacked configuration. The at least one intermediate layer may have a hole formed therethrough that defines a chamber having arc suppression material disposed therein. A first conductive terminal may be formed on a first end of the fuse and a second conductive terminal may be formed on a second end of the fuse. At least one fusible element may connect the first terminal to the second terminal, thus providing an electrically conductive pathway therebetween. A portion of the at least one fusible element may pass through the air gap defined by the hole in the at least one intermediate insulative layer.

### RELATED APPLICATIONS

This application is a continuation-in-part and claims the benefit of U.S. patent application Ser. No. 14/252,846 filed Apr. 15, 2014, entitled “Laminated Electrical Fuse,” which application is itself a continuation-in-part and claims the benefit of U.S. patent application Ser. No. 13/826,058 filed Mar. 14, 2013, entitled “Laminated Electrical Fuse,” which applications are incorporated herein by reference in their entirety.

### FIELD OF THE DISCLOSURE

The disclosure relates generally to the field of circuit protection devices and more particularly to a compact, low cost, high breaking capacity fuse.

### BACKGROUND OF THE DISCLOSURE

In many circuit protection applications it is desirable to employ fuses that are compact and that have high “breaking capacities.” Breaking capacity (also commonly referred to as “interrupting capacity”) is the current that a fuse is able to interrupt without being destroyed or causing an electric arc of unacceptable duration. Certain fuses sold under the name NANO fuse are currently available that exhibit high breaking capacities and are suitable for compact applications, but such fuses are relatively expensive. It is therefore desirable to provide a low cost, high breaking capacity fuse that is suitable for compact circuit protection applications.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In accordance with the present disclosure, a compact, high breaking capacity fuse is provided. An exemplary embodiment of the fuse may include a top insulative layer, at least one intermediate insulative layer, and a bottom insulative layer arranged in a vertically stacked and bonded configuration. The at least one intermediate layer may have a hole formed therethrough that defines an air gap within the fuse. A first conductive terminal may be formed on a first end of the fuse and a second conductive terminal may be formed on a second end of the fuse. At least one fusible element may connect the first terminal to the second terminal, thus providing an electrically conductive pathway therebetween. A portion of the at least one fusible element may pass through the air gap defined by the hole in the at least one intermediate insulative layer.

### BRIEF DESCRIPTION OF THE DRAWINGS

FIG. 1 is an exploded view illustrating a high breaking capacity fuse in accordance with an exemplary embodiment of the present disclosure.

FIG. 2 is a side view illustrating the high breaking capacity fuse shown in FIG. 1 in an assembled configuration.

FIG. 3 is an exploded view illustrating a fuse array in accordance with the present disclosure wherein several high breaking capacity fuses are arranged in a contiguous, arrayed configuration.

FIG. 4 is a perspective view illustrating the high breaking capacity fuse array shown in

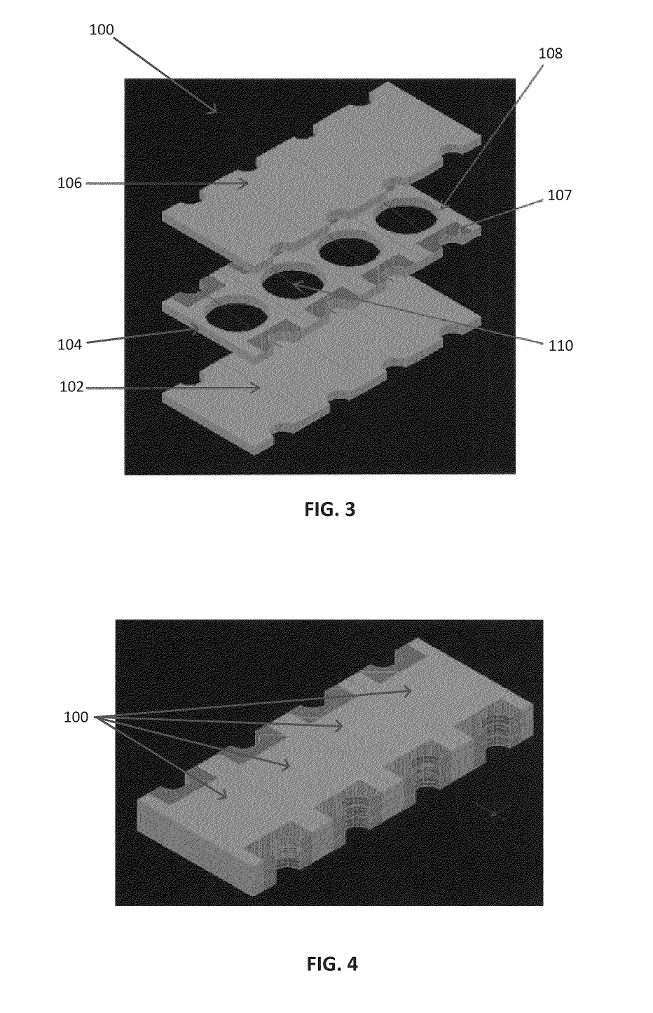

FIG. 3 in an assembled configuration.

FIG. 5 is plan view illustrating components of an alternative high breaking capacity fuse embodiment in accordance with the present disclosure.

FIG. 6 is an exploded view illustrating another alternative high breaking capacity fuse embodiment in accordance with the present disclosure.

FIG. 7 is an exploded view illustrating yet another alternative high breaking capacity fuse embodiment in accordance with the present disclosure.

FIG. 8 is a perspective view illustrating the high breaking capacity fuse shown in FIG. 7 in an assembled configuration.

FIG. 9 is a plan view illustrating another alternative high breaking capacity fuse embodiment in accordance with the present disclosure.

FIG. 10 is an exploded view illustrating the high breaking capacity fuse shown in FIG. 9.

FIG. 11 is a plan view illustrating another alternative high breaking capacity fuse embodiment in accordance with the present disclosure.

FIG. 12 is an exploded view illustrating another of the high breaking capacity fuse shown in FIG. 9.

FIG. 13 is a side view illustrating the high breaking capacity fuse shown in FIG. 9.

### DETAILED DESCRIPTION

The present invention will now be described more fully hereinafter with reference to the accompanying drawings, in which preferred embodiments of the invention are shown. This invention, however, may be embodied in many different forms and should not be construed as being limited to the embodiments set forth herein. Rather, these embodiments are provided so that this disclosure will be thorough and complete, and will fully convey the scope of the invention to those skilled in the art. In the drawings, like numbers refer to like elements throughout.

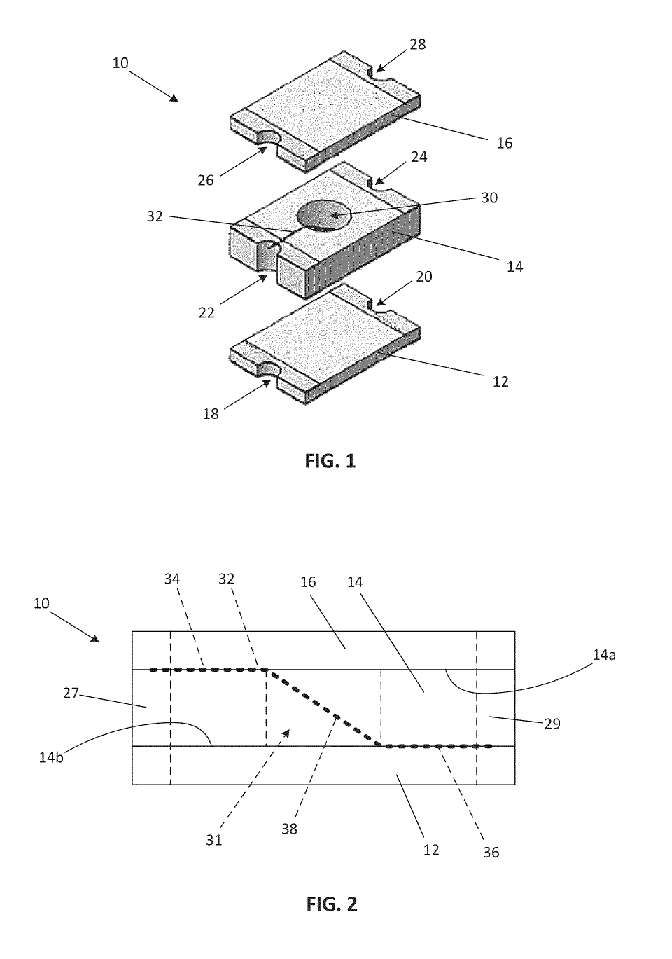

Referring to FIGS. 1 and 2, a first exemplary embodiment of a high breaking capacity fuse 10 (hereinafter referred to as “the fuse 10”) in accordance with the present disclosure is shown. The fuse 10 is shown exploded in FIG. 1 and in a fully assembled configuration in FIG. 2. The fuse 10 may include a bottom insulative layer 12, a middle insulative layer 14, and a top insulative layer 16 disposed in a vertically stacked configuration. When assembled as shown in FIG. 2, the layers 12-16 may be flatly bonded to each other, such as with epoxy or other non-conductive adhesives or fasteners. The layers 12-16 may be substantially rectangular and may be formed of any suitable, electrically insulative material, including, but not limited to, FR-4, glass, ceramic, plastic, etc.

The layers 12-16 of the fuse 10 may have castellations 18, 20, 22, 24, 26, and 28 at their longitudinal ends, such as may be formed by drilling, for providing the assembled fuse 10 with terminals 27 and 29. The longitudinal ends of the layers 12-16 may plated with copper or other electrically conductive materials, such as by a photolithography process or other plating means, to facilitate electrical connection between the terminals 27 and 29 of the assembled fuse and other circuit elements.

The layers 12-16 may be substantially identical, except that the middle layer 14 may be provided with a through-hole 30 formed in a center portion thereof that defines an air gap 31 in the assembled fuse 10. The hole 30 is shown having a circular shape, but it is contemplated that the hole 30 may be formed with a variety of other shapes, such as oval, rectangular, triangular, or irregular. The middle layer 14 may also be thicker than the bottom layer 12 and the top layer 16 as shown in the figures, but this is not critical. It is contemplated that that middle layer 14 may alternatively be thinner or may have the same thickness as the bottom layer 12 and top layer 16. It is further contemplated that the bottom layer 12 or the top layer 16 may be thinner or thicker than the other two layers.

The fuse 10 may include a fusible element 32 disposed intermediate the layers 12-16. Particularly, a first end portion 34 of the fusible element 32 may be disposed on a top surface 14a of the middle layer 14 and a bottom surface of the top layer 16. A second end portion 36 of the fusible element 32 may be disposed on a bottom surface 14b of the middle layer 14 and a top surface of the bottom layer 12. A middle portion 38 of the fusible element 32 may extend diagonally through the hole 30 which defines the air gap 31 in the middle layer 14. The end portions 34 and 36 may be bonded to the plated, longitudinal ends of the layers 12-16, such as by solder or conductive adhesive. The fusible element 32 thereby provides an electrically conductive pathway between the terminals 27 and 29.

The middle portion 38 of the fusible element 32 is a “weak point” that will predictably separate upon the occurrence of an overcurrent condition in the fuse 10. Since the middle portion 38 is entirely surrounded by air and is not in contact with, or in close proximity to, the insulative material that forms the layers 14-16, an electric arc that forms in the middle portion 38 during an overcurrent condition is deprived of fuel (i.e., surrounding material) that might otherwise sustain the arc. Arc time is thereby reduced, which in-turn increases the breaking capacity of the fuse 10.

The fusible element 32 may be formed of any suitable, electrically conductive material, such as copper or tin, and may be formed as a wire, a ribbon, a metal link, a spiral wound wire, a film, an electrically conductive core deposited on a substrate, or any other suitable structure or configuration for providing a circuit interrupt. As will be appreciated by those of ordinary skill in the art, the particular size, configuration, and conductive material of the fusible element 32 may all contribute to the rating of the fuse 10.

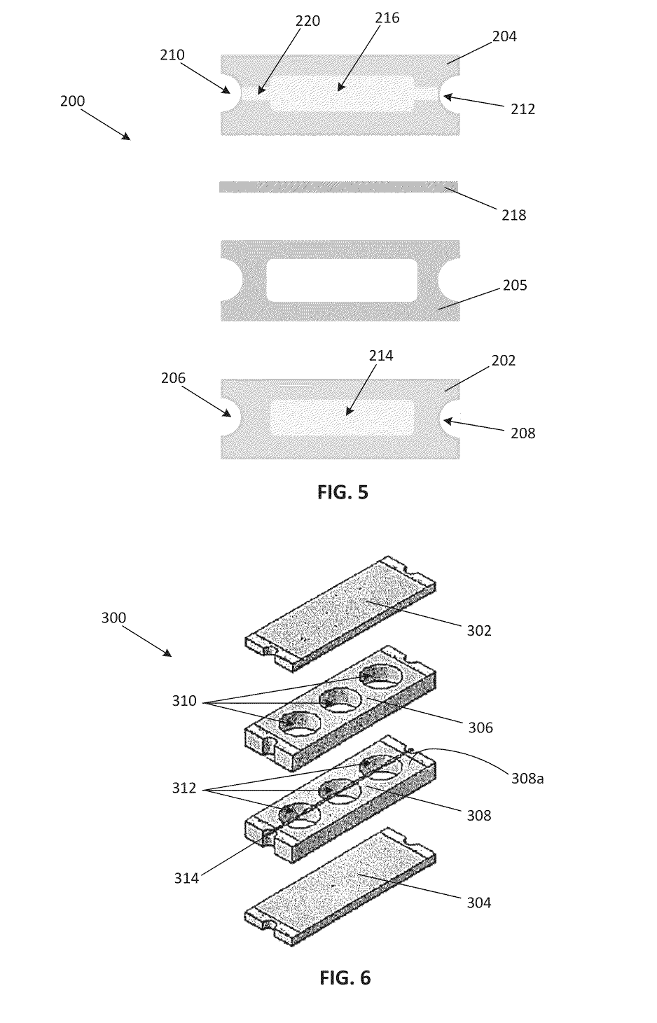

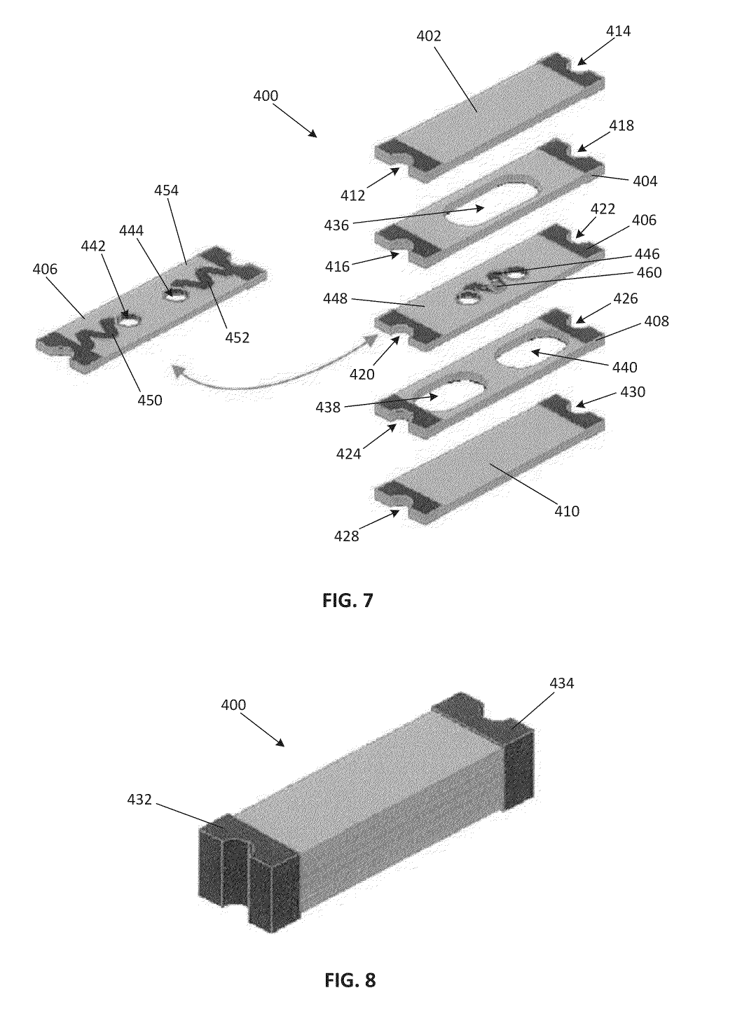

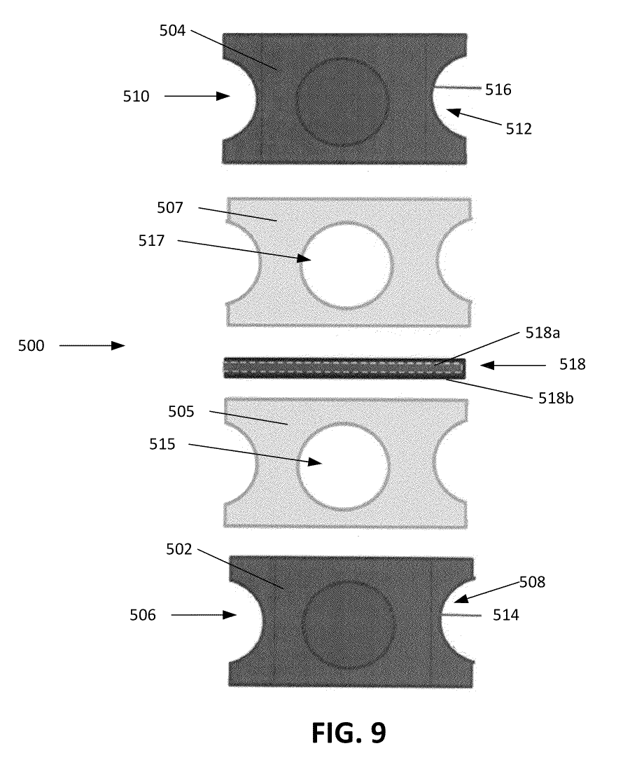

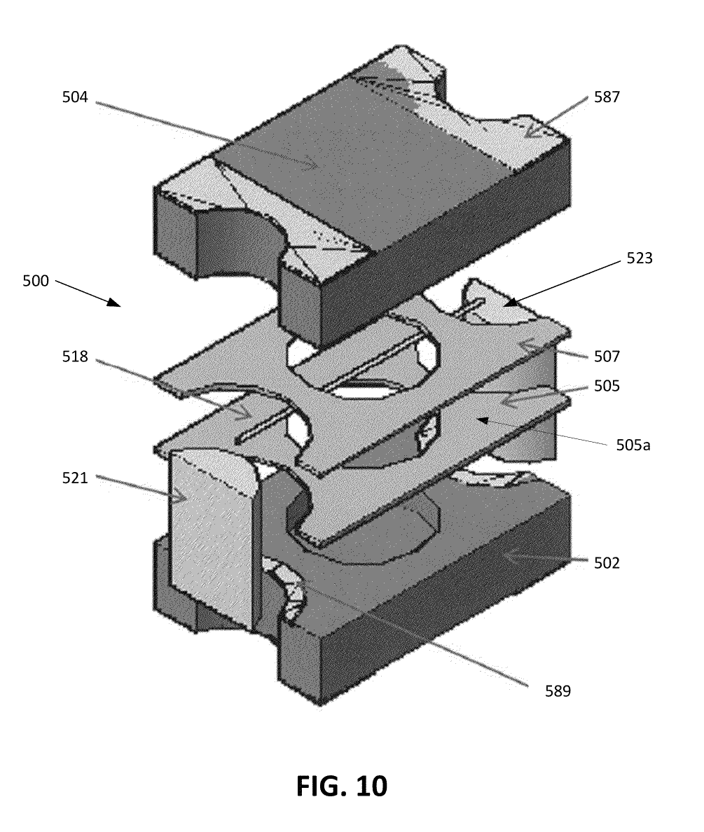

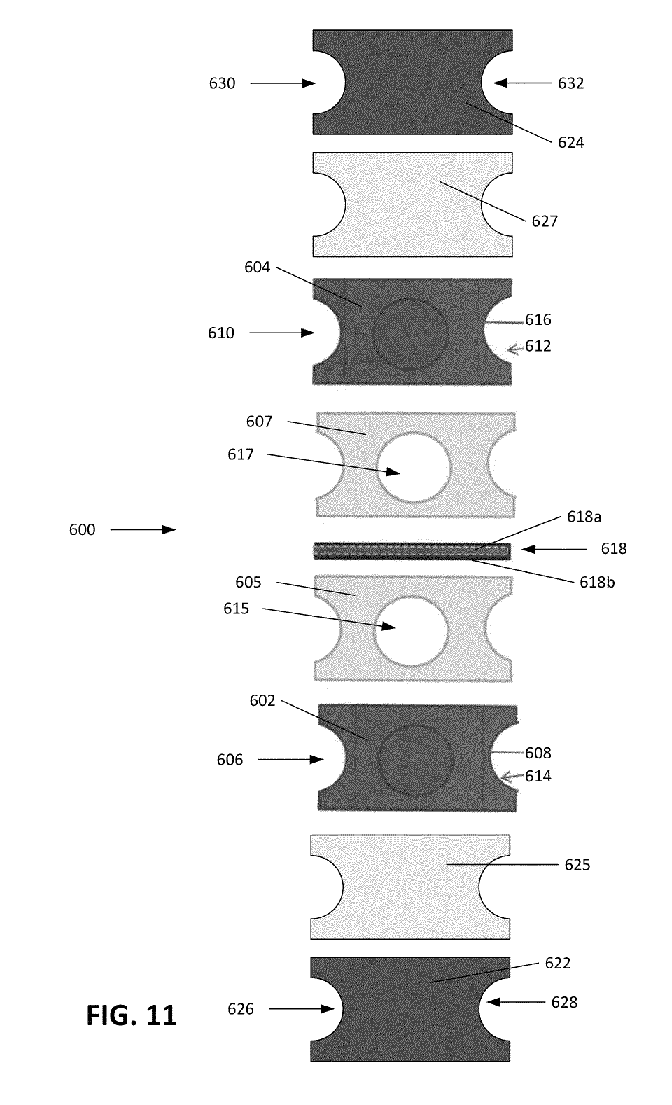

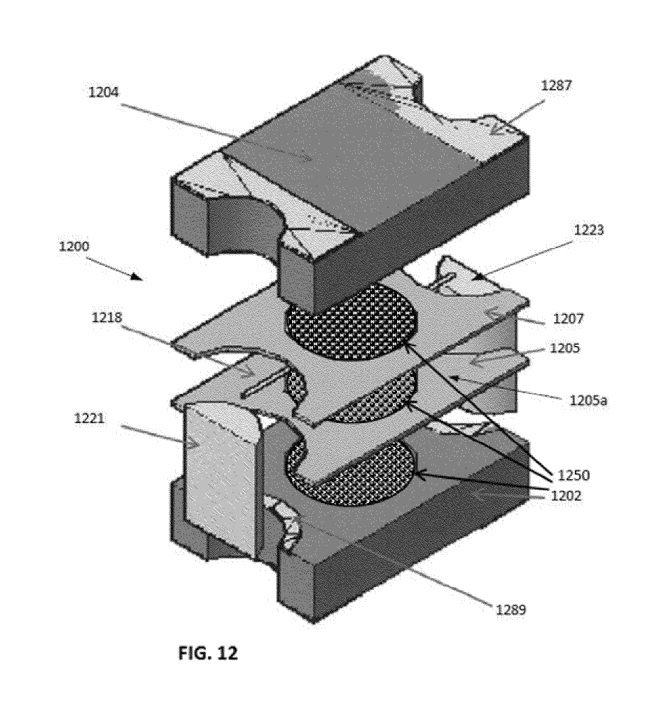

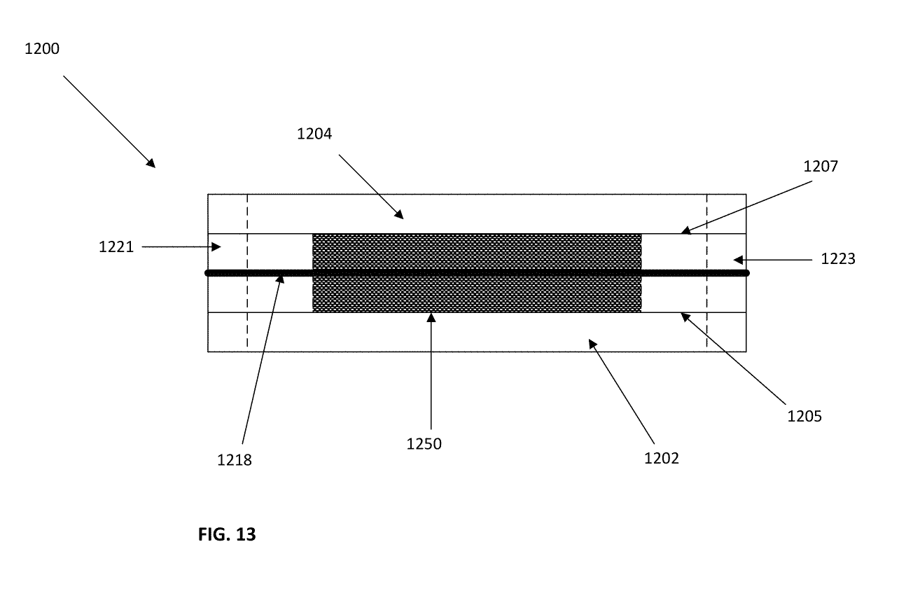

Referring to FIGS. 3 and 4, it is contemplated that several fuses 100 that are substantially identical to the fuse 10 described above may be formed of a single, contiguous bottom layer 102, a single, contiguous middle layer 104, and a single, contiguous top layer 106. Each of the layers 102-106 may have castellations 107 as described above. Like the fuse 10, each of the fuses 100 may have a hole 108 formed through the intermediate or middle layer 104 thereof and a fusible element 110 extending diagonally through the hole 108 for providing enhanced breaking capacity. It is contemplated that the fusible elements 110 may all be identical, or that some or all of the fusible elements 110 may have different configurations and/or ratings relative to others. The fuses 100 are shown in a 4×1 arrayed configuration in FIGS. 3 and 4, but it is contemplated that larger or smaller arrays (e.g. 2×1, 6×1, etc.) with more or fewer fuses 100 may be implemented in a similar manner without departing from the scope of the present disclosure.

FIG. 5 illustrates an exploded view of a fuse 200 in accordance with an alternative embodiment of the present disclosure. The fuse 200 may include a bottom insulative layer 202 and a top insulative layer 204. When the fuse 200 is assembled (not shown) the layers 202 and 204 may be flatly bonded to each other in a vertically stacked configuration, such as with an intermediate layer 205 of epoxy, pre-preg, or with other non-conductive adhesives or fasteners. As shown, the intermediate layer 205 has a similar configuration as layers 202 and 204, however alternative configurations are contemplated herein. The layers 202 and 204 may be substantially rectangular and may be formed of any suitable, electrically insulative material, including, but not limited to, FR-4, glass, ceramic, plastic, etc.

The layers 202 and 204 may have castellations 206, 208, 210, and 212 at their longitudinal ends, such as may be formed by drilling, for providing the assembled fuse 200 with terminals for connection to other circuit elements. The bottom layer 202 may be provided with a routed area 214 on its top surface, and the top layer 204 may be provided with a routed area 216 on its bottom surface. When the fuse 200 is assembled, the routed areas 214 and 216 align with one another to define a central air gap or chamber within the fuse 200. The routed areas are shown as being rectangular in shape, but it is contemplated that the routed areas 214 and 216 may be formed with a variety of other shapes, such as circular, oval, triangular, or irregular.

The fuse 200 includes a fusible element 218 disposed intermediate the layers 202 and 204. Particularly, the longitudinal ends of the fusible element 218 may be disposed within a routed channel 220. The channel 220 is shown as being formed in the top layer 204, but it is contemplated that the channel 220 can alternatively be formed in the bottom layer 202, or that similar channels can be formed in the both the top and bottom layers 202 and 204. In any such configuration, the routed channel(s) may be shallower than the routed areas 214 and 216, and may be of a size and shape that accommodate the fusible element 218 in a close clearance relationship.

When the fuse 200 is assembled, a central portion of the fusible element 218 extends through the air gap defined by the routed portions 214 and 216. The central portion of the fusible element 218 is therefore entirely surrounded by air within the fuse 200, which thereby increases the breaking capacity of the fuse 200 for the reasons described above. Unlike the fusible element 32 described above with reference to FIGS. 1 and 2, the fusible element 218 extends longitudinally straight (i.e., not diagonally) across the fuse 200. The fusible element 218 may be formed of any suitable, electrically conductive material, such as copper or tin, and may be formed as a wire, a ribbon, a metal link, a spiral wound wire, a film, an electrically conductive core deposited on a substrate, or any other suitable structure or configuration for providing a circuit interrupt. As will be appreciated by those of ordinary skill in the art, the particular size, configuration, and conductive material of the fusible element 218 may all contribute to the rating of the fuse 200.

A fuse 300 is shown in the exploded view of FIG. 6 that is substantially similar to the fuse 200 shown in FIG. 5 except that instead of the top and bottom layers 302 and 304 having routed areas formed therein, the fuse 300 is provided with intermediate layers 306 and 308 having holes 310 and 312 formed therethrough. When the fuse 300 is assembled in a vertically stacked configuration, the holes 310 are aligned with the holes 312 and thus define a series of air gaps or chambers within the fuse. The fusible element 314 is disposed on a top surface 308a of intermediate layer 308 and a bottom surface of intermediate layer 306 such that the fusible element extends along the air gaps 310 and 312 and thus provides the fuse 300 with an enhanced breaking capacity as described above. The intermediate layers 306 and 308 are each shown as having three holes 310 and 312 formed therethrough, but it is contemplated that more or fewer holes having alternative shapes may be formed in a similar manner without departing from the present disclosure.

Referring to FIGS. 7 and 8, a fuse 400 in accordance with an alternative embodiment of the present disclosure is shown. FIG. 7 is an exploded view of the fuse 400 and FIG. 8 illustrates a fully assembled configuration. The fuse 400 may include a first insulative layer 402, a second insulative layer 404, a third insulative layer 406, a fourth insulative layer 408, and a fifth insulative layer 410 disposed in a vertically stacked configuration. When assembled as shown in FIG. 8, the layers 402-410 may be flatly bonded to each other, such as with epoxy, pre-preg, or with other non-conductive adhesives or fasteners. The layers 402-410 may be substantially rectangular and may be formed of any suitable, electrically insulative material, including, but not limited to, FR-4, glass, ceramic, plastic, etc.

The layers 402-410 may have castellations 412, 414, 416, 418, 420, 422, 424, 426, 428, and 430 at their longitudinal ends, such as may be formed by drilling, for providing the assembled fuse 400 with terminals 432 and 434. The longitudinal ends of the layers 412-430 may be plated with copper or other electrically conductive materials, such as by a photolithography process or other plating means, to define terminals 432, 434 at respective longitudinal ends of the fuse 400 to facilitate electrical connection with other circuit elements. The terminals 432 and 434 of the assembled fuse 400 may be further plated or coated with conductive materials, such as by dipping or by electroless plating techniques.

Insulative layer 404 may have a hole 436 formed therethrough and the layer 408 may have two longitudinally-spaced holes 438 and 440 formed therethrough. The holes 436-440 are shown as having an oblong shape, but it is contemplated that the holes 436-440 may be formed with a variety of other shapes, such as circular, oval, rectangular, triangular, or irregular. When the fuse 400 is assembled, the hole 436 in the layer 404 may define an air gap or chamber between the layers 402 and 406, and the holes 438 and 440 in the layer 408 may define longitudinally-spaced air gaps between the layers 406 and 410.

The layer 406 of the fuse 400 may have a pair of longitudinally-spaced vias 442 and 444 formed therethrough. The interior surfaces of the vias 442 and 444 may be plated or coated with an electrically conductive material, such as copper. A fusible element 446 may be formed on the top surface 448 (shown on the right side on FIG. 7) of the layer 406, intermediate and electrically connected to the vias 442 and 444. Similarly, fusible elements 450 and 452 may be formed on the bottom surface 454 (shown on the left side on FIG. 7) of the layer 406, intermediate and electrically connected to the vias 442 and 444 and the plated, longitudinal ends of the layer 406. The fusible elements 446, 450, and 452 and the vias 442 and 44 thus provide an electrical pathway between the terminals 432 and 434 of the assembled fuse 400.

When the fuse 400 is assembled, the top surface of the fusible element 446 may be disposed within the air gap defined by the hole 436 in the layer 404, and the bottom surfaces of the fusible elements 450 and 452 may be disposed within the air gaps defined by the holes 438 and 440 in the layer 408. Since these surfaces of the of the fusible elements 446, 450, and 452 are not in contact with, and are not in close proximity to, the insulative material that forms the layers 404 and 408, an electric arc that forms in one or more of the fusible elements 446, 450, and 452 during an overcurrent condition is deprived of fuel (i.e., surrounding material) that might otherwise sustain the arc. Arc time is thereby reduced, which in-turn increases the breaking capacity of the fuse 400.

The fusible elements 446, 450, and 452 may be formed of any suitable, electrically conductive material, such as copper or tin, and may be formed using any suitable plating, coating, or material deposition means, such as by a photolithography process. The fusible elements 446, 450, and 452 are shown in FIG. 7 as having a serpentine shape, but this is not critical. As will be appreciated by those of ordinary skill in the art, the particular size, configuration, shape and conductive material of the fusible elements 446, 450, 452 may all contribute to the rating of the fuse 400. In addition, a portion 460 formed of a material having a lower melting point than the fusible elements 446, 450, and 452 may be formed on one or more of the fusible elements 446, 450, and 452 for creating a “weak point” that will predictably open upon the occurrence of an overcurrent condition in the fuse 400 associated with a particular rating. For example, the portion 460 may be formed of tin with a nickel barrier.

FIG. 9 illustrates a plan view of a fuse 500 in accordance with an alternative embodiment of the present disclosure. The fuse 500 may include a bottom insulative layer 502 and a top insulative layer 504. When the fuse 500 is assembled (not shown) the layers 502 and 504 may be flatly bonded to each other in a vertically stacked configuration, such as with intermediate layers 505 and 507. The intermediate layers 505, 507 may be comprised of epoxy, pre-preg, or other non-conductive adhesives or fasteners. As shown, the intermediate layers 505, 507 have a similar configuration to layers 502 and 504, however alternative configurations are contemplated herein. The layers 502 and 504 may be substantially rectangular and may be formed of any suitable, electrically insulative material, including, but not limited to, FR-4, glass, ceramic, plastic, etc.

The layers 502 and 504 may have castellations 506, 508, 510, and 512 at their longitudinal ends, such as may be formed by drilling, for providing the assembled fuse 500 with terminals for connection to other circuit elements. The bottom layer 502 may be provided with a routed area 514 on its top surface, and the top layer 504 may be provided with a routed area 516 on its bottom surface. When the fuse 500 is assembled, the routed areas 514 and 516 align with one another to define a central air gap or chamber within the fuse 500. The routed areas are shown as being round in shape, but it is contemplated that the routed areas 514 and 516 may be formed with a variety of other shapes, such as rectangular, oval, triangular, or irregular. Additionally, the intermediate layers 505, 507 may have holes 515 and 517 that correspond to the routed areas 514 and 516. As such, the fuse 500 is assembled, the holes 515, 517 and the routed areas 514, 516 align with one another to define the central air gap or chamber.

The fuse 500 includes a fusible element 518 disposed between the intermediate layers 505 and 507. Particularly, the longitudinal ends of the fusible element 518 may be disposed along the longitudinal axis of the intermediate layers 505, 507. Accordingly, when the fuse 500 is assembled, a central portion of the fusible element 518 extends through the air gap defined by the routed portions 514 and 516. The central portion of the fusible element 518 is therefore entirely surrounded by air within the fuse 500, which thereby increases the breaking capacity of the fuse 500 for the reasons described above. Unlike the fusible element 32 described above with reference to FIGS. 1-2, the fusible element 518 extends longitudinally straight (i.e., not diagonally) across the fuse 500. The fusible element 518 may be formed of any suitable, electrically conductive material, such as copper or tin, and may be formed as a wire, a ribbon, a metal link, a spiral wound wire, a film, an electrically conductive core deposited on a substrate, or any other suitable structure or configuration for providing a circuit interrupt. As will be appreciated by those of ordinary skill in the art, the particular size, configuration, and conductive material of the fusible element 518 may all contribute to the rating of the fuse 500. In some examples, the fusible element 518 may be Wollaston wire. More specifically, the fusible element 518 may be a very fine (e.g., less than or equal to 0.01 mm thick) wire. The wire may be have a core 518a, for example, platinum or a platinum alloy and a cladding 518b, such as, for example, silver or a silver alloy. In some examples, the fusible element 518 may be a solid wire and include nickel or a nickel alloy. In some examples, the fuse element 518 may have a core 518a that is less than or equal to 7 microns.

The fuse 500 is shown in the exploded view of FIG. 10 that is substantially similar to the fuse 500 shown in FIG. 9. In particular, the bottom layer 502, the top layer 504, the intermediate layers 505 and 507, and the fusible element 518 are shown. Additionally, terminal portions 521 and 523 are shown. The terminal portions may be formed from a conductive material, such as, for example, tin or a tin alloy. When the fuse 500 is assembled in a vertically stacked configuration, the holes 515, 517 are aligned with the routed areas 514, 516 and thus define an air gaps or chamber within the fuse 500. The fusible element 518 is disposed on a top surface 505a of intermediate layer 505 and a bottom surface (hidden by the perspective view) of intermediate layer 507 such that the fusible element 518 extends along the air gap and thus provides the fuse 500 with an enhanced breaking capacity as described above. The fuse 500 is shown having a single air gap, but it is contemplated that more air gaps may be formed (e.g., similar to the fuse 300 shown in FIG. 6) without departing from the present disclosure. Additionally, metallization 587 and 589 on the castellations are shown. The metallizations 587 and 589 may be made from plating, printing, or the like a conductive material (e.g., copper, tin, nickel, or the like) on the castellations. Furthermore, terminals 521 and 523, which may be formed by plating, dipping, or the like a conductive material (e.g., copper, tin, nickel, or the like) to partially or substantially fill the castellations. In some examples, the terminals 521 and 523 may be formed prior to singulation to protect the fuse element 518 from being damaged during the singulation process. More specifically, the terminals 521 and 523 may be formed on the fuse 500 while it is attached to multiple other fuses 500 (e.g., refer to FIGS. 3-4). Accordingly, when the fuses 500 are separated from each other (also referred to as singulation) the fuse element 518 may be protected from damage.

FIG. 11 illustrates a plan view of a fuse 600 in accordance with an alternative embodiment of the present disclosure. The fuse 600 may include inner insulative layers 602 and 604, bottom insulative layer 622 and top insulative layer 624. When the fuse 600 is assembled (not shown) the layers 602, 604 and 622, 624 may be flatly bonded to each other in a vertically stacked configuration, such as with inner intermediate layers 605 and 607 and outer intermediate layers 625 and 627. The intermediate layers 605, 607 and 625, 627 may be comprised of epoxy, pre-preg, or other non-conductive adhesives or fasteners. As shown, the intermediate layers 605, 607 and 625, 627 have a similar configuration to layers 602, 604 and 622, 624, however alternative configurations are contemplated herein. The layers 602, 604 and 622, 624 may be substantially rectangular and may be formed of any suitable, electrically insulative material, including, but not limited to, FR-4, glass, ceramic, plastic, etc.

The layers 602, 604 and 622, 624 may have castellations 606, 608, 610, 612, 626, 628, 630, and 632 at their longitudinal ends, such as may be formed by drilling, for providing the assembled fuse 600 with terminals for connection to other circuit elements. The inner insulative layer 602 may be provided with a routed area 614 on its top surface, and the top layer 604 may be provided with a routed area 616 on its bottom surface. When the fuse 600 is assembled, the routed areas 614 and 616 align with one another to define a central air gap or chamber within the fuse 600. The routed areas are shown as being round in shape, but it is contemplated that the routed areas 614 and 616 may be formed with a variety of other shapes, such as rectangular, oval, triangular, or irregular. Additionally, the intermediate layers 605, 607 may have holes 615 and 617 that correspond to the routed areas 614 and 616. As such, the fuse 600 is assembled, the holes 615, 617 and the routed areas 614, 616 align with one another to define the central air gap or chamber. In some examples, the routed areas 614, 616 may be holes (not shown) that extend through the layers 602, 604.

The fuse 600 includes a fusible element 618 disposed between the inner intermediate layers 605 and 607. Particularly, the longitudinal ends of the fusible element 618 may be disposed along the longitudinal axis of the inner intermediate layers 605, 607. Accordingly, when the fuse 600 is assembled, a central portion of the fusible element 618 extends through the air gap defined by the routed portions 614 and 616. The central portion of the fusible element 618 is therefore entirely surrounded by air within the fuse 600, which thereby increases the breaking capacity of the fuse 600 for the reasons described above. Unlike the fusible element 32 described above with reference to FIGS. 1-2, the fusible element 618 extends longitudinally straight (i.e., not diagonally) across the fuse 600. The fusible element 618 may be formed of any suitable, electrically conductive material, such as copper or tin, and may be formed as a wire, a ribbon, a metal link, a spiral wound wire, a film, an electrically conductive core deposited on a substrate, or any other suitable structure or configuration for providing a circuit interrupt. As will be appreciated by those of ordinary skill in the art, the particular size, configuration, and conductive material of the fusible element 618 may all contribute to the rating of the fuse 600. In some examples, the fusible element 618 may be Wollaston wire. More specifically, the fusible element 618 may be a very fine (e.g., less than or equal to 0.01 mm thick) wire. The wire may be have a core 618a, for example, platinum or a platinum alloy and a cladding 618b, such as, for example, silver or a silver alloy. In some examples, the fusible element 618 may be a solid wire and include nickel or a nickel alloy. In some examples, the fuse element 618 may have a core 618a that is less than or equal to 7 microns.

The fuse 1200 is shown in the exploded view of FIG. 12 and the side view of FIG. 13 that is substantially similar to the fuse 500 shown in FIG. 9. In particular, the bottom layer 1202, the top layer 1204, the intermediate layers 1205 and 1207, and the fusible element 1218 are shown. Additionally, terminal portions 1221 and 1223 are shown. The terminal portions may be formed from a conductive material, such as, for example, tin or a tin alloy. When the fuse 1200 is assembled in a vertically stacked configuration, a chamber is formed. The chamber may be partially or completely filled with an arc suppressing material 1250 (e.g., silica sand, ceramic powder, or the like) to enhance the current and voltage interrupting properties of the fuse.

The fusible element 1218 is disposed on a top surface 1205a of intermediate layer 1205 and a bottom surface (hidden by the perspective view) of intermediate layer 1207 such that the fusible element 1218 extends through the chamber and the arc suppressing material 1250. Thus the fuse 1200 is provided with an enhanced breaking capacity and arc suppression qualities as described above. The fuse 1200 is shown having a single chamber, but it is contemplated that more chambers may be formed (e.g., similar to the air gaps or chambers in fuse 300 shown in FIG. 6) without departing from the present disclosure. Furthermore, where more than one chamber is provided, one or more of these chambers may be filled with arc suppression material 1250. In particular, less than all of the chambers (e.g., 2 out of 3, or the like) may be filled with arc suppression material.

Additionally, metallization 1287 and 1289 on the castellations are shown. The metallizations 1287 and 1289 may be made from plating, printing, or the like a conductive material (e.g., copper, tin, nickel, or the like) on the castellations. Furthermore, terminals 1221 and 1223, which may be formed by plating, dipping, or the like a conductive material (e.g., copper, tin, nickel, or the like) to partially or substantially fill the castellations. In some examples, the terminals 1221 and 1223 may be formed prior to singulation to protect the fuse element 1218 from being damaged during the singulation process. More specifically, the terminals 1221 and 1223 may be formed on the fuse 1200 while it is attached to multiple other fuses 1200 (e.g., refer to the configuration in FIGS. 3-4). Accordingly, when the fuses 1200 are separated from each other (also referred to as singulation) the fuse element 1218 may be protected from damage.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While the present invention has been disclosed with reference to certain embodiments, numerous modifications, alterations and changes to the described embodiments are possible without departing from the sphere and scope of the present invention, as defined in the appended claim(s). Accordingly, it is intended that the present invention not be limited to the described embodiments, but that it has the full scope defined by the language of the following claims, and equivalents thereof.

What is claimed:

1. A high breaking capacity fuse comprising:
a top insulative layer, a first and a second intermediate layers, and a bottom insulative layer arranged in a vertically stacked configuration, wherein the first and second intermediate layers have a hole formed therethrough defining a chamber within the fuse, wherein the chamber is at least partially filled with an arc suppressing material;
a first conductive terminal formed on a first end of the fuse;
a second conductive terminal formed on a second end of the fuse; and
at least one fusible element connecting the first terminal to the second terminal and providing an electrically conductive pathway therebetween, wherein a portion of the fusible element passes through the chamber.

2. The high breaking capacity fuse of claim 1, wherein the top insulative layer and the bottom insulative layer comprise routed areas that align with the holes in the first and second intermediate layers, and wherein the chamber is formed from the holes and the routed areas.

3. The high breaking capacity fuse of claim 1, wherein the first and second intermediate layers are a non-conductive epoxy material.

4. The high breaking capacity fuse of claim 1, wherein the top and bottom insulative layers are comprised of a material selected from the group consisting of F-R4, glass, ceramic, or plastic.

5. The high breaking capacity fuse of claim 1, wherein the arc suppressing material comprises silica sand, ceramic powder, or a mixture of silica sand and ceramic powder.
